(19) United States
(12) Patent Application Publication
(10) Pub. No.: US 2010/0263965 A1
(43) Pub. Date: Oct. 21, 2010

(54) OIL SUPPLY AND DISCHARGE FOR A TRANSMISSION

(75) Inventor: Gereon Hellenbroich, Aachen (DE)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (DE)

(21) Appl. No.: 12/601,688

(22) PCT Filed: May 26, 2008
(86) PCT No.: PCT/EP2008/004176

§ 371 Date: Nov. 24, 2009

(30) Foreign Application Priority Data
May 24, 2007 (DE) 10 2007 024 513.2

(51) Int. Cl. F16H 57/04

(52) U.S. Cl. 184/6.12; 475/159

(57) ABSTRACT

The invention relates to a drive system in which components for a front transverse arrangement in a motor vehicle, such as the clutch, shaft, and transmission, are disposed in a casing that is preferably pot-shaped. The oil is centrally supplied via the shaft. An effective centrifugal force allows a certain oil level to be established within the casing, said oil level once again being drained by accordingly discharging oil, preferably parallel to the shaft.

### CROSS-REFERENCE TO RELATED APPLICATIONS

This application is the U.S. national phase of PCT/EP2008/004176 filed May 26, 2008, which claims priority of German Patent Application 10 2007 024 513.2 filed May 24, 2007.

### FIELD OF THE INVENTION

The present invention pertains to a drive system that features a casing, wherein components are arranged within the casing. These components can in particular consist of a clutch, a shaft and/or a transmission, particularly a planetary gear set or parts thereof. The invention furthermore discloses a method for lubricating a drive system that is arranged in a casing.

### BACKGROUND OF THE INVENTION

It is known that rotating components of a drive such as, for example, planetary gear sets or even clutches, operate in a compartment that contains oil, particularly in transmissions. This is the case, for example, in conventional stepped automatic transmissions. The oil is not only required for lubrication, but also for cooling purposes. The oil is frequently supplied through a central shaft, wherein the oil is driven radially outward by the lubricating oil pressure and/or under the influence of centrifugal forces. After the respective lubrication and cooling of one or more components, the oil is splashed radially outward and is usually collected in an oil sump of an oil supply circuit.

### SUMMARY OF THE INVENTION

The present invention is based on the objective of disclosing a lubricating oil system for a drive that makes it possible to realize a compact arrangement and a broader scope of application of the system, particularly for vehicles.

This objective is attained with a drive system, a method for lubricating a drive system, and an application of the system. Advantageous embodiments and additional developments are disclosed in the claims.

The invention proposes a drive system that features a casing for components, namely at least a clutch, a shaft and a transmission, particularly a planetary gear set, as well as an oil supply into the casing and an oil discharge from the casing, wherein the tightness of the casing relative to the supplied oil makes it possible to establish a certain oil level in the casing. According to another aspect of the invention, this drive system preferably can be combined with a proposed method for lubricating a drive system. According to this method, the system arranged in a casing is supplied with oil, for example via a shaft, in order to lubricate components arranged in the casing, wherein at least part of this oil is preferably driven outward in the casing by means of an acting centrifugal force, collected in the casing, preferably on an inner wall thereof, and retained in order to establish an oil level in which a component or the components move at least partially. The casing has a diameter that is larger than the diameter of a clutch arranged in the casing. The oil level is preferably suitable for functioning as an oil reservoir. During operation, the oil level is preferably established over a major part of the inner circumference of the casing. In this respect, a rotation of the casing itself during operation of the system is particularly preferred. The oil level can have the thickness of an oil film, but preferably has a height of one or more millimeters during operation, wherein the oil level has a height of at least one or more centimeters according to one additional development. The oil level preferably rises during operation, particularly during the rotation of the casing, and decreases again when the system is at a standstill. However, the oil level can also change during operation.

The oil can be fed into the casing via a shaft, namely through corresponding conduits provided therein. The oil could also be supplied in a hollow shaft, around a shaft, between a shaft and a hollow shaft or even by a supply system. This supply system can be designed, for example, similar to an oil discharge.

The casing preferably is tight to the extent that an oil-free space is created outside the casing and adjacent thereto. This oil-free space is preferably arranged around the casing. This would make it possible, for example, to keep an element that rotates with the casing free of oil. It would also be possible that another space outside the casing contains oil. This oil can originate, for example, from the casing. However, it would also be possible to feed oil into this space via a different supply system. It would furthermore be possible for oil to leak out of the casing. However, this oil leakage is realized in such a way that a certain oil level is still present within the casing during operation. The oil level is able to supply the components to be lubricated and/or cooled with sufficient oil, particularly when using a multi-disk clutch and/or a planetary gear set. According to one embodiment, it is proposed that the oil be circulated. According to another embodiment, it is proposed that at least part of the oil remain permanently in the casing.

According to an additional development, it is proposed, for example, that a component such as a clutch does not move in the oil level. Rather, parts of the clutch are acted upon by the oil that tends to move outward toward the oil level due to the acting centrifugal force. It would also be possible to supply the clutch with oil by means of a special supply system. According to another embodiment, it is proposed, for example, that at least one component arranged in the casing be separated from the oil level, e.g., by a partition web that extends in the casing. According to one additional development, it is proposed that at least the one component also be separated from the oil flow establishing the oil level within the casing, and not be able to come in contact with the oil. For example, the casing can contain a separate area that is free of oil. This can be achieved, for example, by encapsulating the at least one component. In addition to a first space, the casing can also contain at least one second space that is separated from the first space in an oil-tight fashion. According to one embodiment, the component can consist of the clutch.

An electric machine is preferably arranged in a space arranged around the casing. It would be possible, for example, for the casing to serve as a carrier for the rotor of the electric machine. The electric machine can consist of an electric motor and/or an electric generator. The electric machine can be a dry running machine or a wet running machine.

When utilizing an electric motor, for example, this motor can be realized in the form of a so-called internal rotor electric motor. However, it is also possible to utilize an electric motor with an external rotor. A rotor can be arranged, for example, directly on an outer side of the casing. However, it would also be possible to arrange the rotor in a sidewall. According to one additional development, it is proposed, for example, to provide a web on the casing that rotates therewith. This web forms a mounting for the rotor. According to another embodiment, it is furthermore proposed that the casing contain an indentation with radially circular circumference, in which a rotor and/or stator of the electric motor and/or generator is arranged.

According to another embodiment, it is proposed that the casing does not rotate. In this case, the casing carries a stator of an electric machine such that, for example, a rotor can rotate around the casing. It would also be possible to arrange the stator on the casing such that the rotor does not rotate around the casing itself, but rather a component arranged on the casing.

It is also proposed that the oil discharge preferably take place at least partially parallel to the shaft. This can be realized, for example, by providing a channel that extends in or adjacent to the casing. Corresponding paths for the oil discharge that extend parallel to the shaft can also be provided in the casing or on the casing. In this context, the term “parallel” means that the principal direction of the oil discharge is an axial direction. This type of oil discharge can in particular be distinguished from an oil discharge resulting from the acting centrifugal forces. In the latter instance, the oil would escape from the casing radially outward. In the proposed oil discharge, however, the centrifugal force does not only cause an oil level to be established in the casing. Rather, this also involves the option of an axial discharge. According to one embodiment, a pressure buildup that also acts in the axial direction can be used for this purpose. If the structural conditions are realized accordingly, this promotes, for example, the axial discharge of the oil from the casing. To this end it is proposed, for example, that the casing feature a sidewall that is angled relative to the shaft and that the oil discharge takes place through said side wall. The oil is axially discharged at a location at which an opening for the oil discharge is arranged. The oil discharge can also be at least largely independent of the generated pressure. For example, an inside diameter of a lubricating ring, i.e., an inner surface between oil and air, is subjected to a pressure that, according to definition, amounts to zero. At least an oil drainage is realized due to the rotation and/or gravitation. In addition, the casing or a sealing system for the casing can be realized such that an axial path is provided for the oil discharge. It would also be possible to provide one or more of these axial paths. According to one additional development, it is proposed that the casing contain several openings, preferably bores, through which the oil can drain. This drainage can be achieved, for example, in that the oil begins to drain through the corresponding drain openings for the oil discharge once a certain minimum height of the oil level is reached. The oil can thus be discharged from the casing. The oil discharge can be promoted by generating a negative pressure. This negative pressure can be generated, for example, with the aid of a pump. The components that rotate in the casing and/or the rotation of the casing itself furthermore makes it possible to realize a ventilation in the casing. This ventilation can be used for purposefully establishing an effective pressure difference, for example, due to the arrangement of a corresponding supply and discharge. It is even possible to passively ensure an oil circulation. The oil of the oil level is replenished permanently or discontinuously. This causes the oil level to rise and consequently leads to a pressure buildup. This makes it possible to realize a discharge of the oil that is promoted structurally, for example, by utilizing capillary effects and the like.

According to one additional development of the system, the casing is only penetrable by oil collected in the casing via the oil discharge. To this end, the entire casing can otherwise be realized in an oil-tight fashion. However, it would also be possible for only parts of the casing to be oil-tight while other parts of the casing are penetrable by oil. For example, a first region of the outer circumference of the casing can be radially penetrable by oil situated in the casing. However, another section is completely impenetrable by oil such that the oil of this section can only be discharged from the casing via the oil discharge. The front regions of the casing that are axially and/or radially penetrable or impenetrable by oil can also communicate with one another. This makes it possible to discharge the oil contained in the casing, for example, radially outward via the oil discharge on the one hand, and via the casing on the other hand. For example, at least part of a space that is arranged adjacent to the casing, particularly around the casing, can be at least wetted with oil in this fashion. It is also possible to provide separate spaces that are either free of oil or wetted with oil adjacent to the casing, particularly around the casing. Different components that are respectively sensitive and insensitive to oil can be jointly and compactly arranged around the casing in this fashion.

According to another embodiment, it is proposed that the casing feature one or more closable openings that form part of the oil discharge. These openings make it possible to control whether oil should be discharged or remain in the casing. For example, it can thus be ensured that the casing is also filled with a minimum quantity of oil after the system comes to a standstill. A minimum filling of the casing can be ensured in this fashion. According to one embodiment, it is proposed to utilize a centrifugally actuated valve in this case. When the centrifugal force is effective, the valve opens such that the oil can be discharged from the casing via the oil discharge. However, the valve closes when the centrifugal force decreases. In this case, closing can be realized proportional to the centrifugal force. However, it would also be possible for the valve to open or close abruptly when a minimum centrifugal force is exceeded or not reached. In addition, valves that are actuated electrically, electromechanically, hydraulically or even magnetically can also be used for controlling oil discharge from the casing.

It is preferred that the oil level in the casing drain via an outlet that also rotates in a sidewall of the casing. According to one embodiment, the valve can be arranged in this outlet if such a valve is provided. The outlet preferably allows the oil to drain axially. If different regions in the casing are connected to one another in a communicating fashion, this makes it possible not only to distribute the oil between these regions, but also to evenly discharge the oil via the oil discharge such that a sump of approximately identical height can preferably be regulated in all regions. According to one additional development, a different height of the oil level may be advantageous for operation in the various regions, particularly due to the components that are arranged differently in each region. In this case, a corresponding structural design can ensure that the regions continue to communicate with one another although a different oil level can be regulated. A different height of the oil sump can be realized in the different regions, for example, with the aid of one or more partition walls. A drainage of the oil within the casing can be ensured by means of an overflow over the partition walls or the oil level reaching corresponding openings between the partitions. For example, valves that are actuated centrifugally or that open and close in a different fashion can also be used in this case. In particular, these valves can open and close differently such that an oil discharge from one region does not necessarily lead to a corresponding oil discharge from another region of the casing. For example, the valves used can have different trigger levels with respect to the acting centrifugal force.

It would also be possible to introduce the oil flowing out of the casing into a settling tank, for example, in order to release entrained gas components before the oil is reused in an oil circuit. The settling tank can consist, for example, of a storage tank such as, for example, an oil sump that is arranged outside the casing. When using a dry sump lubrication, it would furthermore be possible to use an oil container in which the oil flowing out of the casing is initially collected in order to release gas components, solid components or the like before its further use. It has proved advantageous to filter the oil flowing out of the casing and/or the oil flowing into the casing. This filtering prevents the admission of solid components dissolved in the oil. In addition, said filtering prevents the entrainment of solid components that can appear in the oil flowing through the casing due to the active elements arranged in the casing. Another function of the filtering process consists, in particular, of preventing deposit at various locations of abrasive particles produced, for example, due to wear of the elements. In order to prevent deposits within the casing, it is proposed, for example, that oil conduits extend axially. These oil conduits can consist, for example, of grooves or channels that are arranged in the surface of the inner side of the casing and/or in radially extending walls within the casing. A specific oil flow can be regulated within the casing in this fashion, wherein particles or the like can be deposited in the casing. In order to remove such a deposit of particles from the casing, it would be possible to provide a corresponding particle trap in the form of a screen. For example, this screen is removably arranged in the casing. It would also be conceivable to provide an externally accessible region within the casing to enable removing such a filter from the casing without having to disassemble the casing itself. For example, it can be ensured that no increased abrasion of components rotating within the casing occurs within the framework of regular maintenance procedures.

In a motor vehicle, the drive system is preferably utilized in the form of a transverse arrangement. The space-saving accommodation of all components and the connection to other components in particular allows utilization in the form of a front transverse arrangement, particularly in a hybrid motor vehicle, because with such a solution, the coupling to an internal combustion engine and the accommodation of a generator or an electric motor can also be realized within the small available space.

### BRIEF DESCRIPTION OF THE DRAWINGS

Other advantageous embodiments and additional developments are described below with reference to the drawings. The described characteristics are not, however, limited to the individual embodiments. On the contrary, the individual characteristics illustrated in the figures can also be combined with other characteristics of other embodiments, and in particular with the characteristics of the preceding description, in order to realize additional developments. The illustrated characteristics should, in particular, not be interpreted in a restrictive sense, but rather can also fulfill their function in the form of equivalent means. In these drawings:

FIG. 1 shows a first embodiment of a drive system;

FIG. 2 shows a schematic representation of a casing with options for arranging an electric machine;

FIG. 3 shows a schematic representation of the accommodation of the system in a motor vehicle in the form of a front transverse arrangement;

FIG. 4 shows another schematic embodiment;

FIG. 5 shows an additional development of the embodiment illustrated in FIG. 4;

FIG. 6 shows an additional development with an electric motor with internal rotor;

FIG. 7 shows an additional development with an electric motor with external rotor, and

FIG. 8 shows a transverse arrangement with automatic transmission.

### DETAILED DESCRIPTION OF THE INVENTION

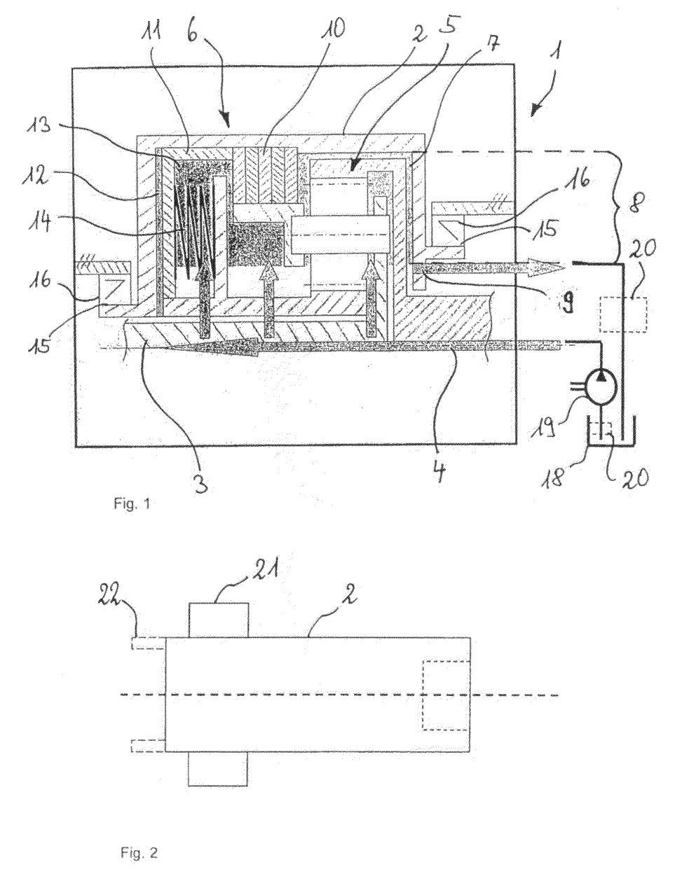

FIG. 1 shows a schematic exemplary embodiment of a drive system 1. A casing 2 surrounds part of a shaft 3. The casing 2 can comprise one, two or more parts and consist, for example, of plastic and/or metal. Oil is centrally supplied into the casing 2 via an oil supply 4 that extends through the shaft 3. This is indicated with arrows. The oil is driven outward in the direction of the inner side of the casing 2 due to an acting centrifugal force and/or a lubricating oil pressure. A transmission 5, in this case a planetary gear set, and a clutch 6 are arranged in the casing 2. The clutch 6 preferably moves completely in the oil, i.e., surfaces of the clutch 6 to be contacted are arranged in the oil of an oil level 7 to be established. The oil level 7 should be interpreted as a thickness 8 that is regulated in the casing 2 due to the acting centrifugal force. This thickness 8 is adjusted by means of the oil quantity that is centrally supplied via the oil supply 4 and/or the oil quantity that is discharged via an oil discharge 9. The oil discharge 9 is preferably contained in an end face of the casing 2 and features an outlet at this location. The oil discharge 9 preferably extends axially relative to the shaft in at least one region. Consequently, it is possible to centrally align the oil supply 4 in the axial direction and to realize the oil discharge 9 in the axial direction as well. The oil can flow through the oil supply 4 and the oil discharge 9 in opposite directions. However, they can also be arranged such that the oil respectively flows through the oil supply 4 and the oil discharge 9 in the same direction.

According to FIG. 1, the clutch 6 with its disks 10 is arranged in the casing 2 adjacent to the transmission 5. The disks 10 are engaged by means of an actuating piston 11. The actuating piston 11 preferably features a pressure compensation. Oil is present in a first space 12. Pressure builds up in this space due to the acting centrifugal force. If this pressure were not compensated, it would cause the clutch 6 to engage although it was not actuated. The first space 12 is filled with oil in order to thus realize the control of the actuating piston 11. A second space 13 is also filled with oil in order to realize the compensation. Consequently, the centrifugal force also exerts a corresponding compressive force upon the oil present in this space, wherein this compressive force acts opposite to the compressive forces generated by the oil in the first space 12. The oil present in the second space 13 can consist, in particular, of the oil of the described oil level. An adjustment of the relative effective surface of the actuating piston 11 makes it possible for the forces thus generated to at least approximately compensate one another. This difference in the effective forces can be taken into account in the design of a regulating spring 14 acting upon the actuating piston 11. If the actuating piston 11 should be activated, an additional compressive force is exerted upon the first space 12 such that the compressive force acting via the second space is neutralized and the regulating spring 14 can be compressed. However, the activation can also be realized automatically, with the pressure difference being regulated due to the centrifugal force only. In addition, it can become effective in both directions as well, i.e., one or more springs press together the clutch that is actively opened by means of the centrifugal force or one or more springs press open the clutch that is actively closed by means of the centrifugal force.

FIG. 1 furthermore shows that the transmission 5 is at least partially covered with oil. When using a planetary gear set, the planetary wheels can preferably revolve in the oil. This also applies to the disks 10 of the clutch 6. In addition to the lubrication thus caused, such a utilization of oil also makes it possible to carry off heat. This heat exchange ensures that neither the clutch 6 nor the transmission 5 can overheat. Consequently, a higher or lower heat flow can be carried off depending on the oil flow resulting for each component.

The casing 2 preferably also forms part of a sealing concept. For this purpose, the casing 2 preferably features one or more sealing surfaces 15. The sealing surfaces 15 preferably serve for the arrangement of one or more seals 16 that are realized, in particular, in the form of radial shaft seals. The escape of oil flowing through the casing 2 is prevented in this fashion, and an axially extending oil supply 4, as well as an oil discharge 9 arranged parallel thereto, can be realized while simultaneously creating a space 17 that is free of oil. The oil discharge 9 preferably leads directly into an oil sump or into an oil reservoir 18 that can form part of a dry sump lubrication. The reservoir 18 preferably consists of a central reservoir. However, it would also be conceivable to arrange a settling chamber downstream of the oil discharge 9, wherein gases, particularly air, dissolved in the oil by the revolving planetary wheels, for example, can be separated in said settling chamber before the oil is introduced into the reservoir 18. The central reservoir 18 also supplies the oil supply 4 with oil by means of an oil pump 19, for example, as indicated in the figure. The settling chamber arranged upstream of the reservoir 18 should preferably be arranged upstream of the oil pump 19. Different positions of the settling chamber 20 are indicated in an exemplary fashion with broken lines.

The exemplary structure of the system 1 in the casing 2 according to FIG. 1 can be realized differently. For example, the clutch can have a different design. It would also be possible to utilize a different type of transmission. One or more partitions can be provided between the individual components arranged in the casing 2 to enable filling the regions thus created with oil differently. An oil compensation of the above-described type also can be realized only partially in this fashion. Consequently, a self-engaging clutch can be constructed: the clutch closes automatically above a certain speed. In this case, an external actuation of the clutch 6 is not required. Consequently, the clutch 6 and the piston 11 can also be influenced by adjusting the position of the oil discharge 9. The incorporation into a corresponding drive concept also allows a versatile construction of the casing 2 that can include, for example, corresponding supports for the shaft and/or other attachments and components.

FIG. 2 shows a schematic representation of the casing 2 according to FIG. 1. In this exemplary arrangement, a rotor 21 of a not-shown electric machine is attached to the casing 2. If this rotor is arranged in the space 17 that surrounds the casing 2 and is free of oil, the electric machine does not have to be provided with a corresponding seal. An exemplary carrier 22 is also schematically illustrated in this figure, wherein a rotor of the electric machine can also be arranged on said carrier. In addition, a rotor or a stator can also project into the casing 2. For example, the casing 2 can be provided with an indentation in one end face for this purpose. This indentation is illustrated in an exemplary fashion with broken lines.

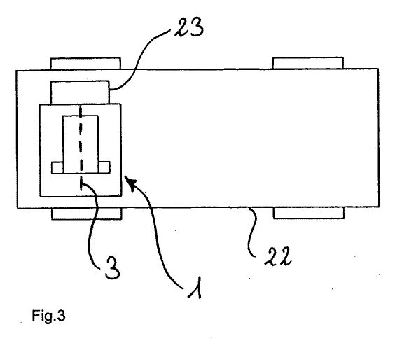

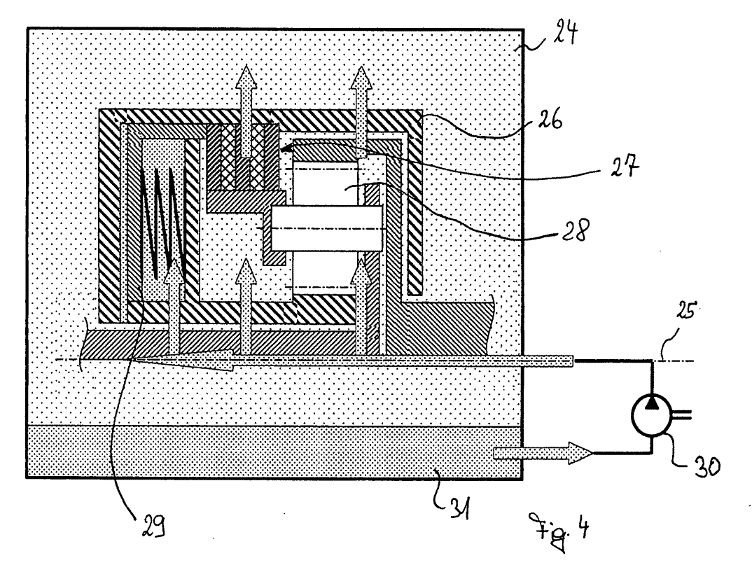

FIG. 3 shows one preferred application of the system 1. This system is installed into a motor vehicle 22 in the form of a front transverse arrangement. The shaft 3 of the system is preferably connected to a shaft of an internal combustion engine in the form of a direct axial connection and/or extends parallel thereto. However, any other type of connection can also be considered. Due to the front transverse arrangement, the weight can be positively utilized for increasing traction, particularly in a front-wheel drive vehicle. The space-saving arrangement of the system components also allows its utilization in a front transverse arrangement, particularly in hybrid vehicles, because electric machines can be directly connected to the system without requiring an excessively large construction thereof.

FIG. 4 shows a schematic representation of a space 24 wetted with oil. This oil-wetted space is arranged around a rotational axis 25. For example, this oil-wetted space 24 contains a pot 26 with a clutch 27, a planetary gear set 28 of an epicyclic gear, and an actuating piston 29 arranged therein. Due to the fact that all components are situated in the oil-wetted space 24 and that oil supply simultaneously takes place along the rotational axis 25, only the components that are sealed accordingly can remain free of oil. Since the oil is supplied along the rotational axis 25, the components such as the actuating piston 29, the planetary gear set 28 and partially also the clutch 27 are otherwise supplied with oil as respectively indicated with corresponding arrows that branch off the oil supply along the rotational axis 25. The oil supply can be realized, for example, by means of an electrically operated pump 30 that pumps oil upward into the oil-wetted space from the oil reservoir 31. In addition, an oil mist can be adjusted in the oil-wetted space itself with corresponding structural measures.

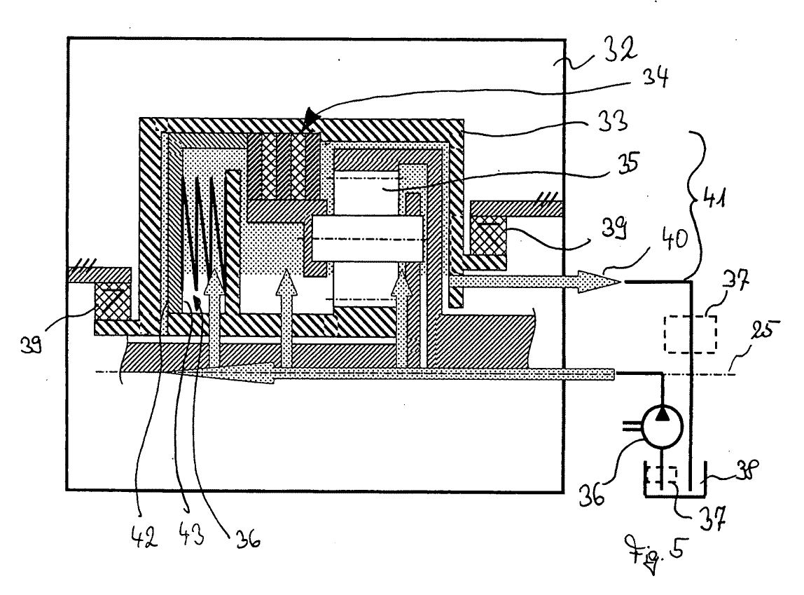

A few components illustrated in FIG. 5 correspond to the embodiment according to FIG. 4. However, the space that was referred to as an oil-wetted space 24 above is now a space 32 that is free of oil in the illustration according to FIG. 5. Rotating components are arranged in this dry space as shown, for example, a pot 33, a clutch 34, a planetary gear set 35 and an actuating piston 36. The oil supply to the rotating components preferably also takes place along the rotational axis 25 in this case. An oil pump 36 driven by an electric motor is once again illustrated in an exemplary fashion. Since the oil circulates in a circuit, one or more cavities 37 can be provided in which the circulating oil can settle, particularly can be degassed, before it is returned to the reservoir 38 or removed therefrom. The rotating components are sealed in the pot 33 by means of corresponding sealing elements 39. In addition, an oil discharge 40 that is illustrated in the form of an arrow extends out of the pot 33. Consequently, the thickness 41 of an oil ring forming within the pot 33 depends, for example, on the oil pump and its pressure buildup, on a rotational speed, and on a discharge of oil from the pot 33. Such a design furthermore causes one piston side 42, for example, of the actuating piston 36 to be completely acted upon with oil while the opposite piston site 43 is only partially acted upon with oil. In addition, a generated pressure difference is utilized in connection with the spring or other elastic means as described above. This also applies to the effect of the oil on the components that revolve within the thickness 41 of the oil ring. Corresponding sealing elements 39 ensure that the rotating elements have a sufficient oil supply, particularly with respect to the function of the respective element; in addition, this makes it possible to structurally utilize the thus enabled dry space 32.

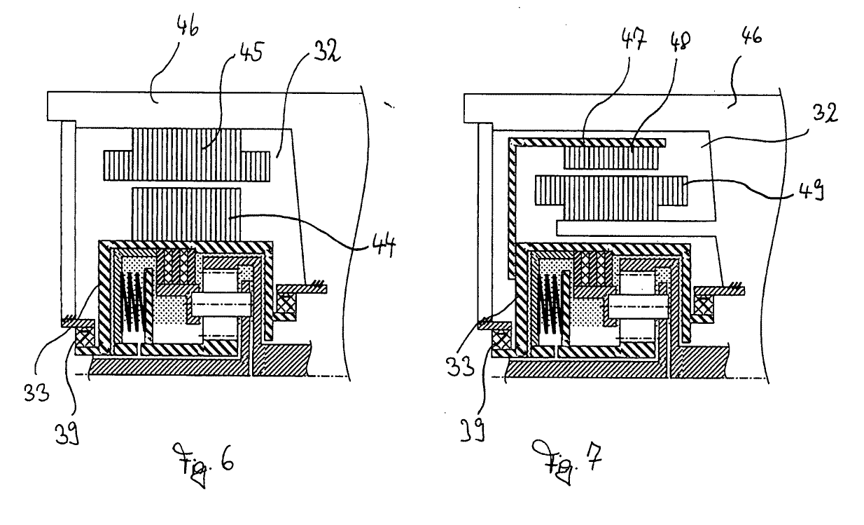

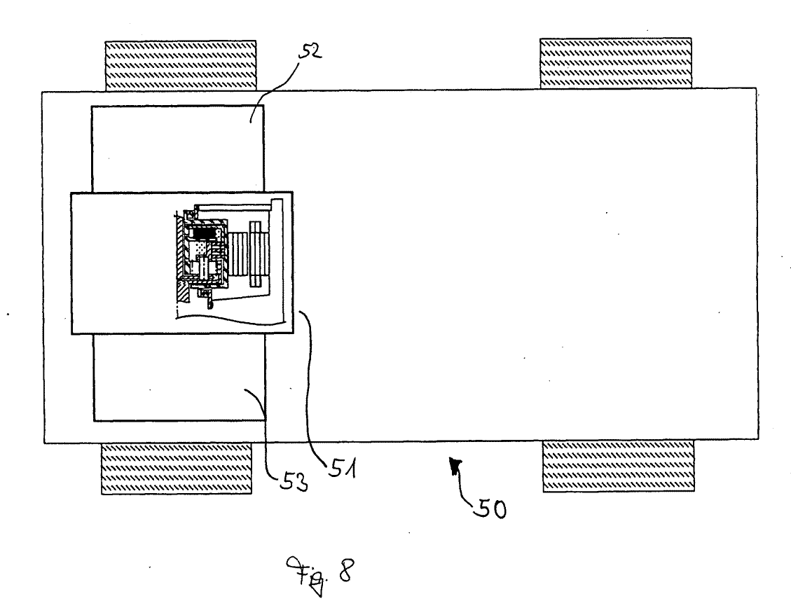

FIGS. 6 and 7 respectively show two different variations of the further utilization of the dry space. FIG. 6 shows an electric motor with an internal rotor that is based on the embodiment according to FIG. 5. In this case, the pot 33 is provided with a rotor 44. A stator 45 is connected to a housing 46 opposite the rotor 44. For example, the housing 46 enables a sealing element 39 to ensure a corresponding oil leak-tightness of the dry space 32.

FIG. 7 shows an embodiment according to FIG. 5 that is supplemented with an electric motor with external rotor. In this case, the pot 33 is connected to a carrier element 47. The rotor 48 is arranged on the carrier element 47. A stator 49 is connected to the housing 46 and arranged opposite the rotor 48. In this case, the oil leak-tightness of the dry space 32 is also ensured with the aid of sealing elements 39.

FIG. 8 schematically shows one preferred application. In this case, a system with an electric motor is installed into the front of a schematically illustrated motor vehicle 50 in the form of a transverse arrangement. The system consists, for example, of a system according to FIG. 5 that is supplemented with an electric motor with internal rotor as illustrated in an exemplary fashion in FIG. 6. The unit 51 thus formed is connected to an internal combustion engine 52 on the one hand, and to a preferably automatic transmission 53 on the other hand.

It is claimed:

1. A drive system comprising: a casing which rotates during operation of at least a clutch, a shaft and a transmission, particularly a planetary gear set, with an oil supply into the casing and with an oil discharge from the casing, wherein the tightness of the casing relative to the supplied oil makes it possible to establish a certain oil level in the casing.

2. The system according to claim 1, characterized by the fact that an oil-free space is arranged outside the casing and adjacent thereto, particularly around said casing.

3. The system according to claim 1, characterized by the fact that an electric machine is arranged in the oil-free space.

4. The system according to claim 1, characterized by the fact that the casing serves as a carrier for a rotor of an electric machine.

5. The system according to claim 1, characterized by the fact that the casing extends around the shaft in a pot-shaped fashion.

6. The system according to claim 1, characterized by the fact that the casing is arranged such that it is rotatable about the shaft.

7. The system according to claim 1, characterized by the fact that the oil discharge extends at least partially parallel to the shaft.

8. The system according to claim 1, characterized by the fact that the casing features a side wall that is angled relative to the shaft, wherein the oil discharge extends through said sidewall.

9. The system according to claim 1, characterized by the fact that the casing is only penetrable by oil collected in the casing via the oil discharge.

10. A method for lubricating a drive system that is arranged in a casing, said method comprising supplying oil via a supply that at least partially extends axially or axially parallel, preferably a shaft, in order to at least lubricate, preferably lubricate and cool, components in the casing, wherein the oil is collected in the casing, preferably on an inner wall thereof, and retained in order to establish an oil level in which the components move at least partially.

11. The method according to claim 10, characterized by the fact that the casing rotates, wherein the oil level is built up until part of the oil level drains via an outlet that also rotates in a side wall of the casing.

12. The method according to claim 10, characterized by the fact that a compensation force for an actuating piston, particularly a clutch piston, is exerted upon part of the oil by means of an acting centrifugal force.

13. The method according to claim 10, characterized by the fact that the oil flowing in the casing is at least partially retained in the casing when the drive is at a standstill.

14. The method according to claim 10, characterized by the fact that different regions in the casing communicate with one another in order to distribute the oil between the regions.

15. The method according to claim 10, characterized by the fact that the oil flowing out of the casing is drained into a settling chamber in order to release entrained gas components before the oil is reused in an oil circuit.

16. The method according to claim 10, wherein said method is utilized in a motor vehicle having a front transverse arrangement.

17. The method according to claim 15, wherein said method is utilized in a hybrid motor vehicle.

18. The system according to claim 1, wherein said system is utilized in a motor vehicle having a front transverse arrangement.
